(19) United States
(12) Patent Application Publication
(10) Pub. No.: US 2005/0104905 A1
(43) Pub. Date: May 19, 2005

(54) Character input method and device

(75) Inventor: Yoshikiko Yamamoto, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/985,061

(22) Filed: Nov. 9, 2004

(30) Foreign Application Priority Data
Nov. 13, 2003 (JP) 2003-384247

(51) Int. Cl. G09G 5/00

(52) U.S. Cl. 345/672

(57) ABSTRACT

A character input method and device is described in which a character table is scrolled in X and Y directions with a pointing device disposed at a character input device. The character table includes desired characters. A desired character is selected from the desired characters and is displayed in a particular area of a character table display screen of the character input device. The selected desired character is determined in order to input the selected desired character to a main display screen of the character input device.

### BACKGROUND OF THE INVENTION

1. Field of the Invention

The present invention relates to a character input method and device which make it possible to easily select and input, for example, a character and which are used in, for example, a cellular phone.

2. Description of the Related Art

Various types of character input devices of an electronic apparatus, such as a cellular phone, having a display screen have been developed. (Refer to Japanese Unexamined Patent Application Publication Nos. 2003-150303 and 2003-209607.)

A typical example of the character input device is shown in FIG. 9. It has twelve keys 15 that are marked with, for example, the alphabetical letters and Japanese characters provided in accordance with the Japanese syllabary. One of the keys is pressed one or more times in order to select and input a desired character.

In a character input method using the character input device having such a structure, for example, a hiragana character [symbol] is selected by pressing the key 15 marked with the number 3 and a hiragana character [symbol] three times at [symbol] , [symbol] , and [symbol] .

Accordingly, in the character input device shown in FIG. 9, one of the keys 15 must be pressed a number of times in order to search for a desired character. Therefore, it takes time to carry out the input operation, causing a user's finger to become tired or to hurt.

For example, in selecting the hiragana character [symbol] as mentioned above, when, while trying to successively carry out shifting from the hiragana character [symbol] to the hiragana characters [symbol] and [symbol] , the user accidentally carries out the shifting beyond the hiragana character [symbol] , and selects a hiragana character [symbol] , the user cannot shift back to any of the previous characters to which the he/she has shifted. In this case, the user must continue pressing the key 15, and carry out the shifting operation once again from the hiragana character [symbol] after a hiragana character [symbol] is displayed. Consequently, the user experiences a poor operational feel.

A pointing device is provided in a character input device for selecting a desired character from a character table, such as a table of the Japanese characters arranged in accordance with the Japanese syllabary, on a display screen.

In such a character input device, since a wide screen area is required for displaying the character table, it is difficult to reduce the size of the character input device.

### SUMMARY OF THE INVENTION

Accordingly, it is an object of the present invention to provide a character input method and a character input device for use in the method, which make it possible to select a desired character and display it on a display screen by a simple operation and which provides good operational feel.

To this end, according to a first aspect of the present invention, there is provided a character input method comprising the steps of scrolling a character table in X and Y directions with a pointing device disposed at a character input device, the character table including desired characters, selecting a desired character from the desired characters and displaying the selected desired character in a particular area of a character table display screen of the character input device, and determining the selected desired character in order to input the selected desired character to a main display screen of the character input device.

According to a second aspect of the present invention, there is provided a character input device comprising a main display screen, a character table display screen for displaying a desired character for inputting to the main display screen, a pointing device for scrolling in X and Y directions a character table for displaying on the character table display screen, character determining means for determining the desired character displayed on the character table display screen as a result of selecting the desired character from the character table in order to display the desired character on the main display screen, a memory for storing one or more pieces of character table data including characters capable of being input to the display screen, and a controlling unit for carrying out a controlling operation so that at least a desired character table data content stored in the memory is displayed on the character table display screen, the character table is scrolled on the basis of the operation of the pointing device, and the determined desired character is displayed on the main display screen on the basis of the operation of the character determining means.

In a first form based on the second aspect, the memory stores a plurality of patterns of character tables, and the character tables include character type selection keys for switching to a desired character table to be displayed on the character table display screen by selecting the desired character table from the plurality of patterns of character tables and determining the desired character table.

In a second form based on the second aspect or the first form, the character table display screen is disposed in part of the main display screen.

According to the character input method of the present invention, if a user moves his/her finger on the surface of the pointing device towards the left and right while a desired character table is displayed on the character table display screen, it is possible to scroll the character table back and forth in the X directions. If the user moves it on the surface of the pointing device upwards and downwards, the character table can be scrolled back and forth in the Y directions. By the scrolling, a desired character is selected from the character table, is displayed in a particular area of the character table display screen of the character input device, and is determined, so that the desired character is easily input to the main display screen of the character input device.

Accordingly, it is not necessary to press a key of a numeric keypad a number of times as it is in related input devices. In addition, the pointing device makes it possible to easily scroll the character table, so that the operational feel is improved.

According to the character input device of the present invention, the controlling unit carries out a controlling operation so that desired character table data stored in the memory is displayed on the character table display screen, the character table is scrolled on the basis of the operation of the pointing device, and a determined desired character is displayed on the main display screen on the basis of the operation of the character determining means. Therefore, it is possible to easily carry out the character input method of the present invention.

In the case in which a plurality of patterns of character tables, such as a katakana character table, a hiragana character table, an alphabet/number table, and a symbol/figure table, are stored in the memory, disposing character type selection keys in part of the character tables make it possible to easily change the character type by the same simple operation as that carried out to select a character, thereby extending the range of choice of selection of characters that can be input. If one character table becomes compact, it is possible to easily and speedily scroll the character table, so that the time required for searching for a desired character can be reduced.

### BRIEF DESCRIPTION OF THE DRAWINGS

FIG. 1 is a plan view of the main portion of a character input device of an embodiment of the present invention;

FIG. 2 illustrates a control structure of the character input device of the embodiment of the present invention;

FIG. 3 shows a hiragana character table in the character input device of the embodiment of the present invention;

FIG. 4 shows a katakana character table in the character input device of the embodiment of the present invention;

FIG. 5 shows an alphabet/number character table in the character input device of the embodiment of the present invention;

FIG. 6A is a conceptual diagram illustrating the separation of characters from a character table in a character input method of an embodiment of the present invention, and FIG. 6B shows an example of a display of the characters on a character table display screen;

FIG. 7A is a conceptual diagram illustrating the separation of characters from the character table in the character input method of the embodiment of the present invention, and FIG. 7B shows an example of a display of the characters on the character table display screen;

FIG. 8A is a conceptual diagram illustrating the separation of characters from the character table in the character input method of the embodiment of the present invention, and FIG. 8B shows an example of a display of the characters on the character table display screen; and

FIG. 9 shows a numeric keypad used in a related character input device and comprising keys having Japanese hiragana characters (arranged according to the Japanese syllabary) and the alphabetical letters marked on them.

### DESCRIPTION OF THE PREFERRED EMBODIMENTS

A character input device of an embodiment of the present invention will be described.

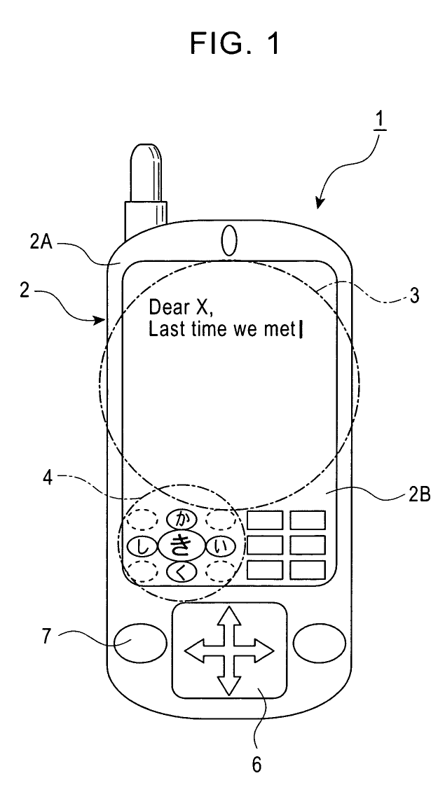

FIG. 1 is a schematic view of a character input device 1 of a cellular phone of an embodiment of the present invention, in which a document is prepared by using a mail function of the cellular phone.

The character input device 1 of the embodiment is disposed at the surface of a casing 2A of the cellular phone, and comprises a main display screen 3 for displaying the content of a mail and a character table display screen 4 for displaying a desired character to be input to the main display screen 3. In the embodiment, a portion of the main display screen 3 (that is, the lower left portion of the main display screen 3) is illustrated as the character table display screen 4. More specifically, in FIG. 1, a wide area (shown by an alternate long and short dash line) of the upper portion of a central liquid crystal display screen 2B is used as the main display screen 3 for displaying the content of a mail, and the lower left portion (indicated by a double-dotted chain line in FIG. 1) is used as the character table display screen 4 for displaying a desired character.

In the embodiment, the character table display screen 4 can display five characters in the form of a cross, that is, one character in the center and the remaining four characters above, below, to the left, and to the right of the center character by separating the five characters from a character table. The center position is a particular area for displaying a selected character input to the main display screen 3 by operating a determining key (described later). It is possible to dispose the character table display screen 4 at the surface of the casing 2A independently of the main display screen 3. The number of characters displayed on the character table display screen 4 is not limited to five as mentioned above. It is also possible to display characters obliquely to the upper left and right and to the lower left and right of the particular area (shown by dotted circles in FIG. 1), so that a total of nine characters can be displayed.

The main display screen 3 and the character table display screen 4 constitute displaying means 5 in the character input device 1 of the embodiment.

The character input device 1 of the embodiment further comprises a pointing device 6 and a determining key 7. The pointing device 6 is used for scrolling a character table in X directions and Y directions (horizontally and vertically in FIG. 1). The character table has desired characters which are arranged on the basis of a predetermined order and is displayed on the character table display screen 4. The determining key 7 serves as character determining means for determining the aforementioned desired character displayed in the particular area of the character table display screen 4 in order to display it on the main display screen 3.

In the embodiment, the pointing device 6 is a planar pointing device comprising a related electrostatic sensor. If an operator moves his/her finger horizontally on the surface of the pointing device 6, the character table is scrolled horizontally back and forth in the X directions, whereas if the operator moves his/her finger vertically on the surface of the pointing device 6, the character table is scrolled vertically back and forth in the Y directions.

Pressing the determining key 7 not only determines the character displayed in the particular area of the character table display screen 4 by operating the pointing device 6, but also determines a desired character table to be displayed on the character table display surface 4 when the desired character table is selected from a plurality of patterns of character tables (described later).

The character determining means is not limited to the determining key 7. For example, if the character determining means detects the pressing of the pointing device 6 in z directions (that is, directions perpendicular to the plane of FIG. 1), the independently disposed determining key 7 may be omitted, so that the determining operation is achieved by the detection of the pressing of the pointing device 6 in the z directions.

The pointing device 6 and the determining key 7 constitute inputting means 8 in the character input device 1 of the embodiment.

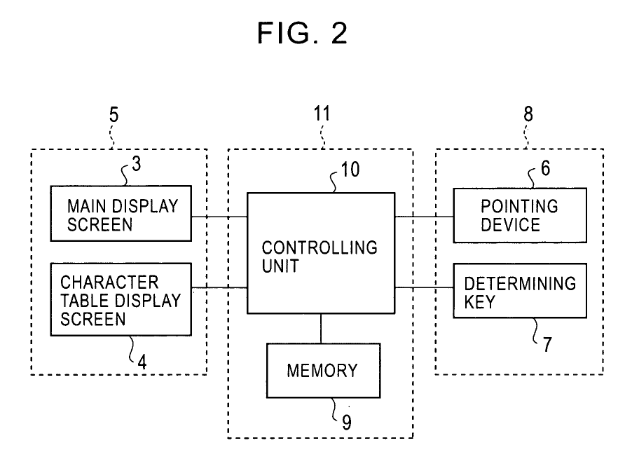

As shown in FIG. 2, the character input device 1 of the embodiment further comprises a memory 9 and a controlling unit 10. The memory 9 stores data of character tables including characters that can be input to the display screen. The controlling unit 10 performs a controlling operation so that the data is stored in the memory 9, a selected desired character table is displayed on the character table display screen 4, the character table is scrolled on the basis of the operation of the pointing device 6, and a determined desired character is displayed on the main display screen 3 on the basis of the operation of the determining key 7.

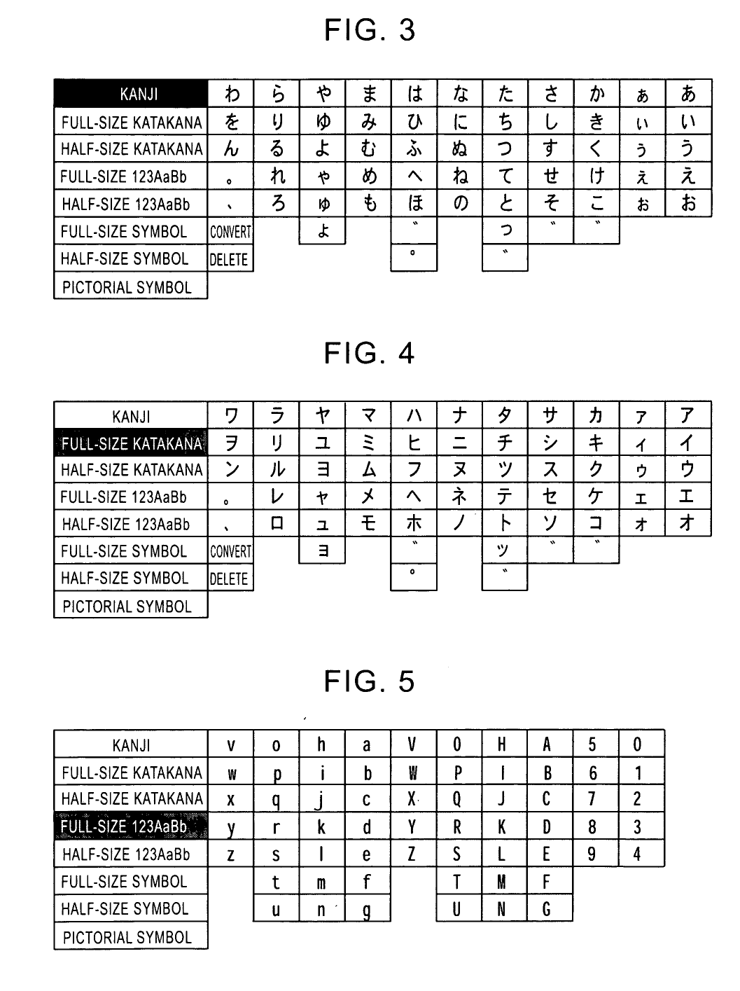

Data of the plurality of patterns of character tables is stored in the memory 9. Examples of the patterns of character tables are a hiragana character table arranged in accordance with the Japanese syllabary (shown in FIG. 3), a katakana character table arranged in accordance with the Japanese syllabary (shown in FIG. 4), and an alphabet/number character table (shown in FIG. 5). The character tables include character type selection commands for switching the character table displayed on the character table display screen 4 by selecting and determining a desired character table from the plurality of patterns of character tables (refer to FIGS. 3 to 5). In, for example, the hiragana and katakana character tables, it is possible to, for example, also include voiced consonants, punctuations, a convert command, and a delete command (see FIGS. 3 to 5).

In the character input device 1 of the embodiment, the memory 9 and the controlling unit 10 constitute controlling means 11.

A method for inputting a character by the character input device 1 will be described.

The method for inputting a character of an embodiment comprises scrolling a character table including desired characters in the x and Y directions by the pointing device 6 of the character input device 1, displaying a selected desired character in the particular area of the character table display screen 4 of the character input device 1, and determining the selected and displayed desired character by pressing the determining key 7 in order to input the desired character to the main display screen 3 of the character input device 1.

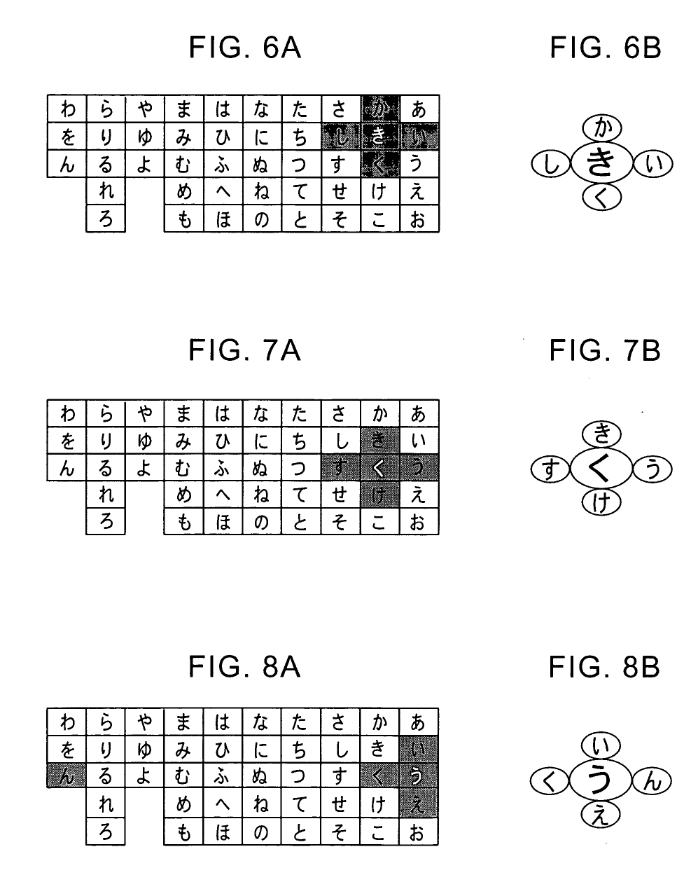

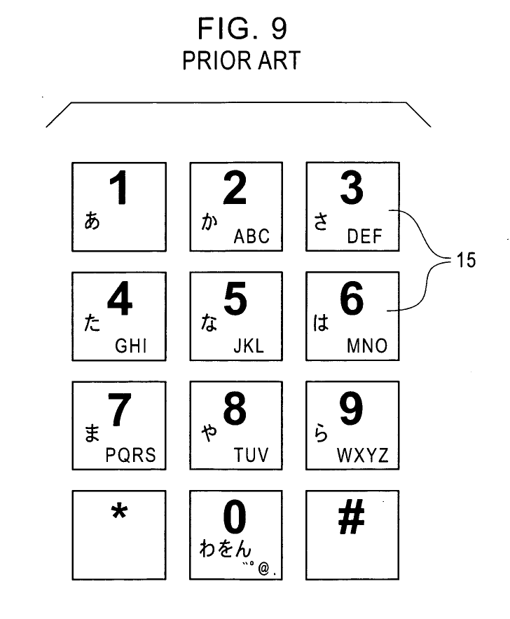

The method will be described in more detail taking as an example, a character table including the hiragana characters arranged in accordance with the Japanese syllabary in five rows and ten columns (refer to FIGS. 6A, 7A, and 8A).

For example, when the hiragana character [symbol] in a column including the hiragana character [symbol] and a row including the katakana character [symbol] is displayed in the particular area of the character table display screen 4, with regard to the arrangement in the character table shown in FIG. 6A, five hiragana characters that are shown in FIGS. 1 and 6B ( [symbol] , [symbol] , [symbol] , [symbol] , and [symbol] ) are separated from the character table and displayed on the character table display screen 4 with the four hiragana characters [symbol] , [symbol] , [symbol] , and [symbol] being disposed above, below, to the right, and to the left of the center hiragana character [symbol] . Here, in the embodiment, the character in the particular area is displayed slightly larger than the other characters.

When, in this state, a finger is moved upward on the pointing device 6, the character table is scrolled in the Y direction. As a result, as shown in FIG. 7B, the hiragana character [symbol] is displayed in the particular area of the character table display screen 4, and the hiragana characters [symbol] , [symbol] , [symbol] , and [symbol] disposed directly above, below, to the right, and to the left of the hiragana character [symbol] , respectively, are displayed on the character table display screen 4 by being separated from the hiragana character table as shown in FIG. 7A.

When, in this state, the finger is moved towards the left on the pointing device 6, the character table is scrolled in the X direction. As a result, as shown in FIG. 8B, the hiragana character [symbol] is displayed in the particular area of the character table display screen 4, and the hiragana characters [symbol] , [symbol] , [symbol] , and [symbol] disposed directly above, below, to the left, and to the right of the hiragana character [symbol] , respectively, are displayed on the character table display screen 4 by being separated from the hiragana character table as shown in FIG. 8A.

Here, it is possible to operate the pointing device 6 by moving the finger towards the right in the X direction and downwards in the Y direction. In addition, it is possible to scroll a character table a plurality of columns and rows at a time instead of one row and one column at a time.

After selecting the desired character by such an operation of the pointing device 6, the selection of the desired character is determined by the operation of the determining key 7.

In the embodiment, the determining key 7 is pressed. As mentioned above, however, if, for example, the character determining means detects the pressing of the pointing device 6 in the z directions, the determining operation may be achieved by the detection of the pressing of the pointing device 6 in the z directions or by two light pressing operations, such as tapping.

By determining the desired character in this way, it is possible to display the character in the particular area of the character table display screen 4 and input the selected character to the main display screen 3.

The operation after inputting the selected character to the main display screen 3, such as converting from hiragana having a predetermined length to kanji, can be carried out by using a related kanji conversion function.

As mentioned above, in the case in which a plurality of patterns of character tables, such as a katakana character table, a hiragana character table, an alphabet/number table, and a symbol/figure table, are stored in the memory, disposing character type selection keys in part of the character tables make it possible to easily change the character type by the same simple operation as that carried out to select a character, thereby extending the range of choice of selection of characters that can be input. If one character table becomes compact, it is possible to easily and speedily scroll the character table, so that the time required for searching for a desired character can be reduced.

The present invention is not limited to the above-described embodiment, so that various modifications may be made as required.

1. A character input method comprising the steps of:
scrolling a character table in X and Y directions with a pointing device disposed at a character input device, the character table including desired characters;
selecting a desired character from the desired characters and displaying the selected desired character in a particular area of a character table display screen of the character input device; and
determining the selected desired character in order to input the selected desired character to a main display screen of the character input device.

2. A character input device comprising:
a main display screen;
a character table display screen for displaying a desired character for inputting to the main display screen;
a pointing device for scrolling in X and Y directions a character table for displaying on the character table display screen;
character determining means for determining the desired character displayed on the character table display screen as a result of selecting the desired character from the character table in order to display the desired character on the main display screen;
a memory for storing character table data including characters capable of being input to the display screen; and
a controlling unit for carrying out a controlling operation so that at least a desired character table data content stored in the memory is displayed on the character table display screen, the character table is scrolled on the basis of the operation of the pointing device, and the determined desired character is displayed on the main display screen on the basis of the operation of the character determining means.

3. The character input device according to claim 2, wherein the memory stores a plurality of patterns of character tables, and wherein the character tables include character type selection keys for switching to a desired character table to be displayed on the character table display screen by selecting the desired character table from the plurality of patterns of character tables and determining the desired character table.

4. The character input device according to claim 2, wherein the character table display screen is disposed in part of the main display screen.

5. The character input device according to claim 3, wherein the character table display screen is disposed in part of the main display screen.
